(19) United States
(12) Patent Application Publication
(10) Pub. No.: US 2004/0248599 A1
(43) Pub. Date: Dec. 9, 2004

(54) [METHOD OF SENDING PERSONALIZED SHORT MESSAGE]

(76) Inventors: Chengshing Lai, Taipei County (TW); James Hu, Nan Ching City (CN)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/709,720

(22) Filed: May 25, 2004

(30) Foreign Application Priority Data
Jun. 5, 2003 (TW) 92115203

(51) Int. Cl. H04Q 7/20

(52) U.S. Cl. 455/466

(57) ABSTRACT

A method of sending a short message via a mobile communication device is provided. A content of a short message is acquired, wherein the content of the short message includes at least a symbol. Next, a definition of the symbol is acquired and an inserting content based on the definition of the symbol is acquired. Next, the inserting content is inserted to replace the symbol to generate a personalized short message. Thereafter, the personalized short message is sent to the respective receivers.

### BACKGROUND OF INVENTION

1. Field of the Invention

This invention generally relates to a method of sending personalized short message, and more particularly to a method of sending personalized short message via a mobile communication device.

2. Description of Related Art

As the information technology advances, the electronic devices such as mobile phones, computers, and personal digital assistants (PDA) are ubiquitous. Those electronic devices provide the need for people in almost every aspect and thus people rely on them more than before. As the electronic technology and the manufacturing technology advance, the human-centered electronic devices with more functions have been developed. To catch up with the fast pace of the modern era, the mobile phone replaces the traditional telephone to facilitate the users communication. Because of its portability and convenience, it is the most convenient and fastest communication tool. As the use of the mobile phones prevails, the functions provided by the mobile phones are more than before, such as sending/receiving short message, sending/receiving email, chat room, and built-in digital camera. Among those functions, the short message service (SMS) is the most widely used function.

SMS is a way to exchange information. After the user inputs the content of the short message via the mobile phone, the telecommunication service system will transmit the short message to the target user. Although the data size of the short message is not that large, because it is very convenient and fast, it is commonly used for sending short information or for leaving message. Nowadays, the users even use the SMS to send the greeting message and some administrative information. As the SMS advances, the traditional SMS can also provide Cell Broadcast SMS based on the whole group in the phone book of the mobile phone, as well as the point-to-point SMS, thereby simplifies the operation for sending the short message to multiple targeting users. However, when using Cell Broadcast SMS, the content of the short message cannot be personalized based on the different targeting users. Because the content of the short message is fixed, it is not allowed to add the name or appellation. Hence, the target users may not feel warm-hearted when they receive the short message. Although the sending user may individualize each short message based on each targeting user, it significantly increases the complexity and burden of the sending user.

### SUMMARY OF INVENTION

The present invention is directed to a method of sending short message via a mobile communication device. When sending the short message to a group of people, the content of the short message can be automatically edited and personalized according to the different target receivers.

According to an embodiment of the present invention, first, a content of a short message is acquired, wherein the content of the short message includes at least a symbol. Next, a definition of the inserted symbol is acquired. Next, an inserting content based on the definition of the inserted symbol is acquired. Next, the inserting content is inserted to replace the inserted symbol to generate a personalized short message. Finally, the personalized short message is sent.

In an embodiment of the present invention, the mobile communication device includes a symbol database, and the step of acquiring the definition of the inserting symbol further includes acquiring the definition of the inserted symbol from the symbol database. In addition, the symbol corresponds to at least one name replacement symbol, an appellation replacement symbol and a supplement content replacement symbol.

In an embodiment of the present invention, the mobile communication device includes an address table database, and the step of acquiring the inserting content based on the definition of the inserted symbol further includes acquiring the inserting content from the address table database. In addition, the inserting content includes at least one name, an appellation and a supplement content.

In light of the above, the method of sending short message, according to an embodiment of the present invention, include inserting at least a symbol in the content of the short message and obtaining the inserting content from the address database embedded in the mobile communication device corresponding to the inserted symbol and replacing the inserted symbol in the content of the short message. Therefore, the content of the short message is edited, personalized, and sent. Accordingly, the present invention allows the user to easily generate and personalize the short message according to the different target receivers.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF DRAWINGS

FIG. 1 is a diagram of a inserting symbol database according to an embodiment of the present invention.

FIG. 2 is a diagram of a address table database according to an embodiment of the present invention.

FIG. 3 is a flow chart of a method of sending short message in accordance with an embodiment of the present invention.

### DETAILED DESCRIPTION

The method of sending a short message, according to an embodiment of the present invention, is suitable a mobile communication device such as a mobile phone, a PDA or other communication devices providing short message service. The mobile communication device has an embedded symbol database and an embedded address table database. Hence, when the user chooses to use the Cell Broadcast SMS to send the short message to a group of people whose names and telephone numbers are listed in the mobile communication device, the user may insert symbols in the content of short message recognizable according to the symbol database to generate personalize the content of the short message according to the address table database corresponding to each telephone number.

FIG. 1 is a diagram of a symbol database according to an embodiment of the present invention. All symbols to be inserted are pre-set in the symbol database 100 of the mobile communication device. The symbols to be inserted includes the name replacement symbol 100a, the appellation replacement symbol 100b and the other supplement content symbols 100c (e.g., *, #, +, etc.).

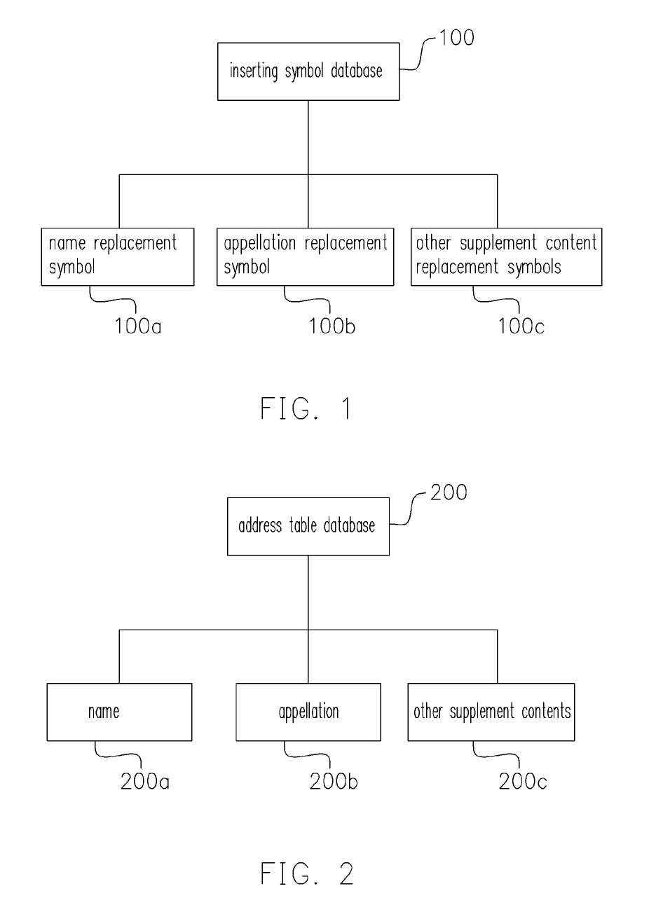

FIG. 2 is a diagram of an address table database according to an embodiment of the present invention. When the user stores the telephone number in the mobile communication device, the user can also store the basic information corresponding to the telephone number at the same time. Each telephone number is stored in the address table database 200. The basic information can include the name 200a, the appellation 200b, and the other supplement contents 200c.

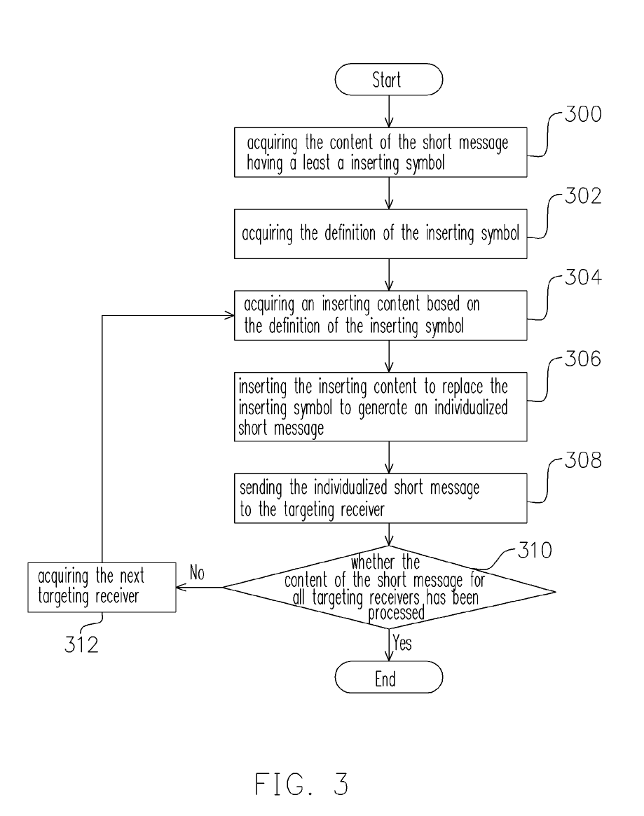

FIG. 3 is a flow chart of a method of sending short message in accordance with an embodiment of the present invention. When the user wishes to send the short message to a group of people, the user can pre-edit the content of the short message and insert some appropriate symbols within the content of the short message, such as *, #, and +, at the appropriate places of the content (such as name, appellation, etc.) For example, the content of the short message can be for example “<#> <*>: How are you doing these days? The New Year is coming . . . May you have a good new year. <+>”.

Referring to FIG. 3, in step S300, the content of the short message read and the positions of the inserted symbols are determined. Next, in step S302, the definition of those inserted symbols are acquired respectively from the symbol database 100 (as shown in FIG. 1). With regard to the above example, the user can pre-define the meaning of the inserting symbols <*> as the name replacement symbol, <#> as the appellation replacement symbol, and <+> as the other supplement symbols in the inserting symbol database.

Referring to FIG. 3, in step S304, the address table database 200 (as shown in FIG. 2) acquired and inserting contents based on the definition of the inserted symbols is acquired. With regard to the above example, the three inserting contents corresponding to the three inserted symbols <*>, <#>, and <+> are Name Bruce Lee; Appellation Upper Classmate; Supplement content Hope your grades get better. In step S306, the inserting contents is inserted to replace the inserted symbols to generate a personalized short message. With regard to the above example, the content of the short message becomes “Upper Classmate Bruce Lee: How are you doing these days? The New Year is coming . . . May you have a good new year. Hope your grades get better.” after the inserting contents are inserted to replace the inserting symbols. Next, in step S308, the personalized short message is sent to the target receiver(s).

Referring to FIG. 3, in step S310, after the first personalized short message is sent, whether the content of the short message for all target receivers has been processed, for example, based on the telephone numbers of the target receivers is checked. If all contents of the short message for all target receivers are processed, the method ends. If not all contents of the short message for all target receivers are processed, and then proceeds to step S312, where the next target receiver is acquired and the steps 304 310 are repeated to personalize the content of the short message for the next target receiver.

In light of the above, the method of sending short message, according to an embodiment of the present invention, is capable of personalizing the content of a single short message for a group of people. According to an embodiment of the present invention the inserting content is inserted into the short message to replace the inserted symbol to generate the personalized short messages with different names, appellations, and supplement contents. Those personalized short messages then are sent to the targeting persons so that they will feel warm-hearted.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

1. A method of sending a short message via a mobile communication device, comprising:
(a) acquiring a content of a short message, said content of said short message including at least a symbol;
(b) acquiring a definition of said symbol;
(c) acquiring an inserting content based on said definition of said symbol;
(d) inserting said inserting content to replace said symbol to generate a personalized short message; and
(e) sending said personalized short message.

2. The method of claim 1, wherein said mobile communication device includes a symbol database, and said step (b) further includes acquiring said definition of said symbol from said symbol database.

3. The method of claim 2, wherein said symbol includes at least one of a name replacement symbol, an appellation replacement symbol, and an supplement content replacement symbol.

4. The method of claim 1, wherein said mobile communication device includes an address table database, and said step (c) further includes acquiring said inserting content from said address table database.

5. The method of claim 4, wherein said inserting content includes at least one of a name, an appellation, and a supplement content.
